(19) United States
(12) Patent Application Publication
(10) Pub. No.: US 2026/0161405 A1
(43) Pub. Date: Jun. 11, 2026

(54) DECOUPLED ORDERED MICRO SEQUENCER

(71) Applicant: Intel Corporation, Santa Clara, CA (US)

(72) Inventors: Muhammad Faisal Azeem, Hillsboro, OR (US); Joju Joseph Zajo, Portland, OR (US); Malihe Ahmadi, Sudbury, MA (US); Xiang Zou, Portland, OR (US); Rangeen Basu Roy Chowdhury, Santa Clara, CA (US)

(73) Assignee: Intel Corporation, Santa Clara, CA (US)

(21) Appl. No.: 18/974,634

(22) Filed: Dec. 9, 2024

(51) Int. Cl. G06F 9/30; G06F 9/22

(52) U.S. Cl. CPC G06F 9/3016; G06F 9/223

(57) ABSTRACT

Methods and apparatus relating to a decoupled ordered micro sequencer are described. In an embodiment, a processor includes a decoder and a Micro Sequencer Unit (MSU). The MSU receives a decode request for an instruction from the decoder in response to a determination by the decoder that the instruction is complex. The decode request includes additional information to allow the MSU to decode the instruction without further communication with the decoder. Other embodiments are also disclosed and claimed.

### FIELD OF THE INVENTION

The present disclosure generally relates to the field of processors. More particularly, some embodiments relate to a decoupled ordered micro sequencer.

### BACKGROUND OF THE INVENTION

Some processors may include decode circuitry to decode an instruction into one or more micro operations (sometimes referred to as “micro-ops” or “uops”).

Depending on the complexity of an instructions, decode operations may impose a large bandwidth penalty on a processor. Hence, the efficiency of decode operations can have a direct impact on processor performance.

### BRIEF DESCRIPTION OF DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a system with various components used to invoke a micro sequencer from decoders, according to an embodiment.

FIG. 2 illustrates a block diagram a system with various components which may be used to invoke a decoupled micro sequencer, according to an embodiment.

FIG. 3 illustrates an example computing system.

FIG. 4 illustrates a block diagram of an example processor and/or System on a Chip (SoC) that may have one or more cores and an integrated memory controller.

FIG. 5(A) is a block diagram illustrating both an example in-order pipeline and an example register renaming, out-of-order issue/execution pipeline according to examples.

FIG. 5(B) is a block diagram illustrating both an example in-order architecture core and an example register renaming, out-of-order issue/execution architecture core to be included in a processor according to examples.

FIG. 6 illustrates examples of execution unit(s) circuitry.

### DETAILED DESCRIPTION OF THE INVENTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, decode operation efficiency can have a direct impact on processor performance. Some processors include a Micro Sequencer or “MS” (sometimes referred to as a microcode sequencer) to assist in decoding of more complex or longer instructions. Generally, the larger the decode pipeline bandwidth (in terms of decoded instructions per cycle), the higher the potential performance impact of a complex instruction needing MS support (henceforth these complex instructions will be called “MS instructions”). The MS is generally a shared resource, so the decode pipeline bandwidth drops below one instruction per cycle when it encounters an MS instruction. In addition, given the need of and instruction and micro-ops to be sent to the rest of the Central Processing Unit (CPU) in-order, and MS micro-ops needing access to decode state, there are other performance degradations beyond the theoretical MS bandwidth in micro-ops per cycle.

To this end, some embodiments provide a decoupled ordered micro sequencer. In an embodiment, a processor includes a decoder and a Micro Sequencer Unit (MSU). The MSU receives a decode request for an instruction from the decoder in response to a determination by the decoder that the instruction is complex. The decode request includes additional information to allow the MSU to decode the instruction without further communication with the decoder. This allows the decoder to proceed to decoding a subsequent instruction after the complex instruction is transferred to the MSU. The additional information may include at least one of: a Micro Sequencer (MS) entry micro operation (uop) instruction pointer, an indicator corresponding to inserted flow, one or more fast branch bits, and a Macro Alias Register (MAR).

Accordingly, some embodiments may provide the ability to scale up performance of a CPU for MS instructions. This may be especially important for some 32-bit based CPUs given the significant number of MS instruction in the 32-bit architecture and/or a Complex Instruction Set Computer (CISC) Instruction Set Architecture (ISA), more generally. Such embodiments may also help design by reducing complexity and design cost of increasing MS micro-ops bandwidth.

Moreover, in some embodiments, one or more of the following features are provided:
(1) Decouple the MS from decode pipelines, such that the MS requests are fire-and-forget and the decoders can move on to decoding the next instructions.
(2) Create the complete micro-op in the MS, instead of relying on some leftover information in the requesting decoders, allowing MS bandwidth to grow independently.
(3) Allow a scalable microarchitecture with a mix of “X” number of decoders and “Y” number of micro sequencers.

By contrast, to solve the high decode bandwidth issue, some CPUs may use pre-decoded instruction information, use clustered decode, or sometimes rely on micro-op caches to bypass decoder and MS when possible. To limit the MS impact, some CPUs may handle multi micro-ops instructions in decoders, such that decoders can generate more than one micro-ops for one instruction in some cases (generally these are however limited to small number of micro-ops to limit the decoder hardware impact and design complexity). These approaches, however, focus on limiting the actual MS instruction.

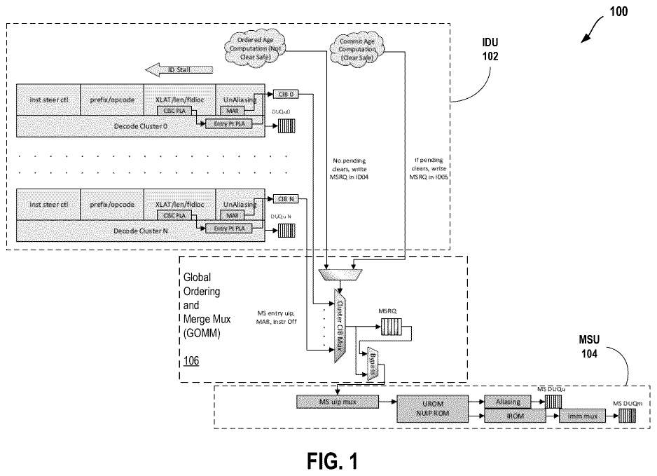

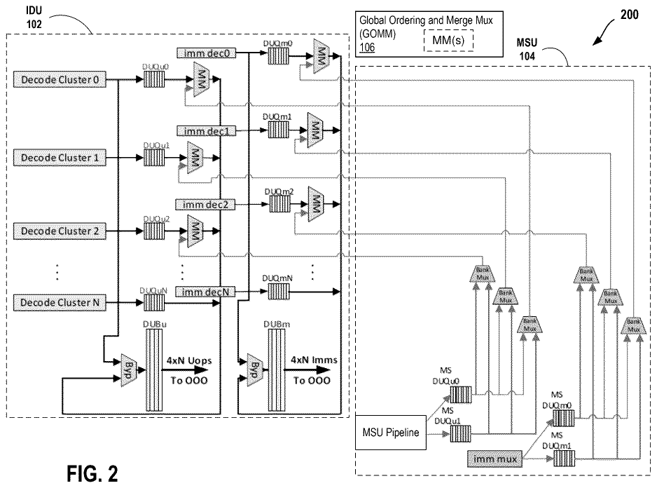

FIG. 1 illustrates a block diagram of a system 100 with various components used to invoke a micro sequencer from decoders, according to an embodiment. System 100 includes an IDU 102 portion and an MSU 104 portion. IDU 102 includes all decoder clusters 0 to N (also interchangeably referred to herein as decoder or decoders more generally), and Decoded Uop Queues (DUQs) (see, e.g., FIG. 2). MSU 104 includes the MS request receiving logic, MS pipeline (as well as Read Only Memories (ROMs), Random Access Memories (RAMs), and/or other memory), Micro Sequencer DUQ (MSDUQ), etc. Additionally, as discussed herein, the terms “multiplexer” and “mux” are interchangeable, “PLA” refers to Programmable Logic Array, “XLAT” refers to translation PLA, “len” or “Len” refer to length decoder; “FLDLOC” or “fldloc” refer to field locator, “MAR” refers to macro alias register, “Uip” or “UIP” refer to uop instruction pointer, “NUIP” refers to next UIP, “IROM” refers to immediate ROM, and “imm” refers to immediate.

In at least one embodiment, the CPU microarchitecture is updated such that the decoders can make requests to MS and move on to the next instruction. This does require that on the MS request, more information would be sent to the MS than what is being sent on many of the current CPUs. In turn, the MS should be able to generate the complete uop that the decoders normally generate for simple instructions, instead of some compressed or intermediate representations. Comparing to some existing designs, this means that a uop “un-aliasing” logic (such as shown by box labeled “aliasing” in FIG. 1) is implemented in the MSU as well. As discussed herein, “un-aliasing” is primarily used to populate fields of uops from UROM with information from macro-instructions. In addition, the unaliasing module may set some hint based on the macro-instructions for the subsequent pipe stages to handle the uops.

The requests to MS can be made in-order or out-of-order. If out-of-order, MS will need an age indication since MS will need to return uops in their age order. So, to decrease complexity as well as limit forward progress issues, an embodiment may choose to make the MS request in order at the cost of some potential performance.

The decoders after making the MS requests, will continue to decode next instructions and put the decoded uops in “per decoder” or “per decode group” Decoded Uop Queues (DUQs). Once a queue is full, the associated decoder(s) will need to wait (or stall as illustrate in FIG. 1), but this should not result in a performance impact if the DUQs are sized well. Similarly, MSU, after generating the uops, will put them in a queue (e.g., MSDUQs). The write and read bandwidth of the MSDUQs may match the MS pipeline bandwidth but can be varied due to design choices in some embodiments. Instruction that require MS handling will be referred to as “CISC: instructions herein.

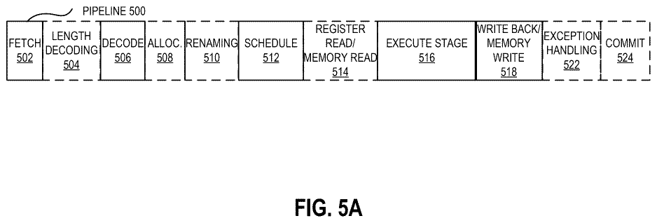

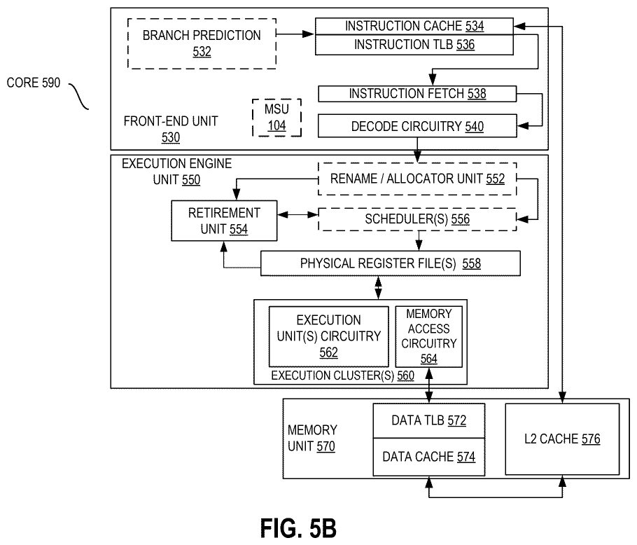

As shown in FIGS. 1 and 2, a global ordering and merge mux (GOMM) logic 106 may be provided, e.g., after various DUQs and MSDUQ (referring to FIG. 2), to order the uops by age and potentially store/combine them in a unified decoded uop buffer (called “DUB”) before sending them to the rest of the processor (such as the execution engine unit 550 if FIG. 5B). This DUB implementation may be skipped if timing requirements permit it. In an embodiment,, ordering and merge multiplexer logic (see, e.g., multiplexers labeled as “MM” in FIG. 2) may be implemented in the GOMM logic 106.

As discussed herein, a “simple” instruction generally refers to an instruction that may be decoded into one to a few uops (e.g., 1 to 4 uops). Also, a “complex” instruction generally refers to an instruction that may be decoded into more uops than a simple instruction (e.g., over 4 uops). Hence, instructions may be grouped into simple and complex instructions. Decoders map simple instructions to single uops and complex instructions to microcode flows, each of which may contain two or more uops to complete the functionality of the corresponding macro-instruction. The translations of simple instructions are stored in XLAT PLA. As shown in FIG. 1, each decoder has one instance of the XLAT PLA. Microcode flows are stored in the microcode ROM (UROM) that is managed by the MSU 104. All Decoders may be capable of decoding both simple and complex instructions and provide uops for simple instructions. Upon decoding a complex instruction, the decoder requests MSU to deliver the uops for microcode flows. The XLAT PLAs may generate the first uop for some of the complex instructions while the rest of the uops are sequenced by the MSU. For others, all the uops may be provided by the MSU. Another reason a decoder may detect a need for MS flows is if special handling is required. A decoder detects the need for an inserted flow based on various conditions (such as page fault, code breakpoint, invalid instruction, etc.), and requests the MS to sequence the uops for the inserted flows.

In an example, presence of a large number of decoders is assumed. These decoders may be implemented in a hierarchy of decode clusters, e.g., each cluster containing four decoders. The number of decoders may be scaled by adding more decoder clusters or increasing the number of decoders per cluster or both. The request to MS may be made at a granularity of decode clusters. Similarly, the DUQs and subsequent age ordering and merge mux may operate at a granularity of decode clusters. This allows flexibility to the design and helps minimize the timing impact at the cost of merging at the uop granularity. However, a decode cluster may also be considered to only contain one decoder, if the design does not require many decoders but aims for flexibility to merge uops at a single uop granularity.

MS Flow Request Protocol

In an embodiment, each decoder cluster in IDU 102 may decode and generate uops for four simple macro instructions per clock cycle. Since multiple clusters may decode CISC instructions in the same cycle and each cluster may decode multiple CISC instructions in the same cycle, a well defined protocol may be used for the clusters to request a MS flow from the MSU 104. When a decoder cluster decodes a valid complex instruction in a cycle, it may request the MSU to service the oldest valid complex instruction by sending a ms_request_packet to the MSU. The ms_request_packets may be written into the “MS Request Queue (MSRQ)” in program order for the MSU to sequence the uops. In this example, the MSRQ only requires one write port. The number of entries in the MSRQ may be dependent on the expected frequency of CISC flows in the given ISA and important workloads. The assumption is that writing one MS request per cycle into the MSRQ is more than sufficient since the MSU will take at least one cycle, but generally take more than one cycle to serve a single MS request. This also opens up the potential for not allowing back-to-back MSRQ request from a single decode cluster for timing purposes or taking multiple cycles to communicate a single MS request for routing optimizations. Moreover, FIG. 1 shows a high-level diagram of an interface from IDU to MSRQ to MSU. Since MSU is now fully decoupled from IDU, MSU now has its own aliasing and immediate aliasing and MSDUQ logic. Generally, aliasing is intended to cover control information and immediate aliasing is intended to cover immediate items associated with the macro-instruction. The high-level concepts are the same between the two an they just deal with different parts of the macro-instruction and have different performance requirements. So, the usage of these two terms are separated for clarity.

### Instruction Decode (ID) Cluster to MSRQ Interaction

In the example discussed above, a decoder cluster needs to stall until its request has been successfully written into the MSRQ since it needs to prevent various decoded information (such as MAR, etc.) for the CISC instruction from being overwritten by subsequent instructions. However, it can take a while for the MS request of a cluster to become ordered (program order) with respect to MS requests from other clusters, causing a backpressure on previous pipeline stages. To avoid this, each decode cluster may include a “CISC Info Buffer” (CIB) to stash or store the current MS request related to the oldest CISC instruction in the cluster and continue decoding subsequent instructions and writing into the DUQ. In addition, a DUQ may be updated with the first uop from XLAT if it is generated by the XLAT. Whether XLAT generates the first uop or not, the CISC_Valid bit in the corresponding DUQ slot is set, which is used by the DUQ read global logic to merge uops from DUQ and MSDUQ.

The decode cluster breaks the decode line once a CISC instruction is detected by taking a ID stall after the CISC instruction (i.e., only if the CISC instruction is not the last instruction). After stashing the MS request for the CISC instruction into the CIB, the decoder cluster may continue to write the subsequent uops into the next DUQ entry in the following cycle. In some embodiments, a maximum of one CISC instruction is processed per cycle.

### ID to MS Transition

When transitioning from ID to MS, there may be one or more bubbles between the last DUQ write and the first MSDUQ write, depending on the depth of the MS pipeline and availability of MSDUQ bypass. If there is an older pending clear in any of the decoders, the number of bubbles in transition from ID to MS can be increased by a cycle to make MSRQ request clear safe. That is because, if there is any pending older clear, CIB ordering may take an extra cycle based on the timing of these clears in the decoder pipeline.

### Merge Mux Operation

FIG. 2 illustrates a block diagram a system 200 with various components which may be used to invoke a decoupled micro sequencer, according to an embodiment. As shown in FIG. 2, a Merge Mux (MM) is responsible for sourcing uops from the two sources (IDU and MSU) in program order and writing them into a DUB. The transitions that MM control manages are further discussed below.

### IDU to MSU

Whenever we reach an ordered DUQ cluster that has a uop marked as CISC_Valid, the rest of the uops for this instruction need to be sourced from the MSDUQ. The uop in the DUQ itself can be valid or invalid depending on the exact instruction. If the uop is valid, all prior uops including this uop is written into the DUB. Subsequent uops from that cluster (and subsequent clusters) are invalidated going to the DUB, which essentially means they are not read in this cycle and will be read in the future. To make this invalidation easier and to avoid having to track partial DUQ chunks, MS Invocation already splits the DUQ chunk when a CISC instruction is encountered in an embodiment. So, MM control may simply move the read pointer for cluster containing the CISC_Valid uop since subsequent uops for that cluster are guaranteed to be in the next DUQ chunk. Encountering a CISC_Valid uop in the DUQ flips the merge mux source control from the DUQ to the MSDUQ and uops from the MS can be read as early as the next cycle if they are ready. This means that uops from the IDU and MSU are not combined in the same cycle and written to the DUB. Note that since the request to the MS can be sent in advance (e.g., as soon as it is detected that this is the oldest ordered instruction needing the MS), it is possible for the MSDUQ to have uops available at the same time that the DUB is being written with the previous DUQ-sourced uops.

A possible optimization includes the MM control scanning ahead for CISC_Valid uops and setting up the MSDUQ read in the same cycle the CISC_Valid uop is read from the DUQ, provided the datapaths to the DUB do not conflict. This will prevent a partial bubble going into the DUB. This can also be done for back-to-back CISC instructions when the MM needs to switch back to IDU only to get the one valid uop for the CISC instruction and switch back to MSU the very next cycle.

### MSU to IDU

For this transition, we continue to source uops from the MS until we observe the End-Of-Macro (EOM) flow marker from the MS which indicates that the end of the MS flow has been reached. This toggles source control back to the DUQ at the uop following the CISC instruction (which will be a new DUQ chunk guaranteed by stall logic in IDU clusters) and we resume from there. The subsequent uop could also be a CISC instruction.

As a first optimization, if the subsequent DUQ uops are being sourced starting at a cluster that does not conflict with the datapaths required to source the last few MS uops for the CISC instruction, they will be written to the DUB in the same cycle. That is MS uops and DUQ uops will be combined into a single line of uops to the DUB. There are two possible scenarios:
1. One uop chunk (e.g., less than 4 valid uops) from MSDUQ (using datapath for cluster 0) and subsequent DUQ chunks (starting at other clusters).
2. Two uop chunks (e.g., about 5 to 8 valid uops) from MSDUQ (using datapaths for clusters 0 and 1) and subsequent DUQ chunks (starting at clusters 2, or higher).

As a second optimization, MM control may look ahead in the DUQs to determine if the next ID instruction is also CISC. If all uops for the instruction is sourced from the MSU, it will not switch the source control back to IDU. Instead, it will continue sourcing subsequent uops from the MSDUQ, thus avoiding a MS to ID and a ID to MS transitions.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

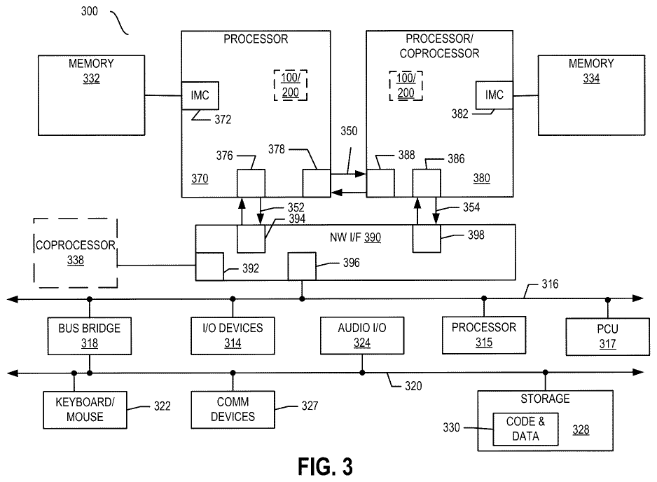

FIG. 3 illustrates an example computing system. Multiprocessor system 300 is an interfaced system and includes a plurality of processors or cores including a first processor 370 and a second processor 380 coupled via an interface 350 such as a point-to-point (P-P) interconnect, a fabric, and/or bus. In some examples, the first processor 370 and the second processor 380 are homogeneous. In some examples, first processor 370 and the second processor 380 are heterogenous. Though the example system 300 is shown to have two processors, the system may have three or more processors, or may be a single processor system. In some examples, the computing system is a system on a chip (SoC).

Processors 370 and 380 are shown including integrated memory controller (IMC) circuitry 372 and 382, respectively. Processor 370 also includes interface circuits 376 and 378; similarly, second processor 380 includes interface circuits 386 and 388. Processors 370, 380 may exchange information via the interface 350 using interface circuits 378, 388. IMCs 372 and 382 couple the processors 370, 380 to respective memories, namely a memory 332 and a memory 334, which may be portions of main memory locally attached to the respective processors.

Processors 370, 380 may each exchange information with a network interface (NW I/F) 390 via individual interfaces 352, 354 using interface circuits 376, 394, 386, 398. The network interface 390 (e.g., one or more of an interconnect, bus, and/or fabric, and in some examples is a chipset) may optionally exchange information with a coprocessor 338 via an interface circuit 392. In some examples, the coprocessor 338 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 370, 380 or outside of both processors, yet connected with the processors via an interface such as P-P interconnect, such that either or both processors' local cache information may be stored in the shared cache if a processor is placed into a low power mode.

Network interface 390 may be coupled to a first interface 316 via interface circuit 396. In some examples, first interface 316 may be an interface such as a Peripheral Component Interconnect (PCI) interconnect, a PCI Express interconnect or another I/O interconnect. In some examples, first interface 316 is coupled to a power control unit (PCU) 317, which may include circuitry, software, and/or firmware to perform power management operations with regard to the processors 370, 380 and/or co-processor 338. PCU 317 provides control information to a voltage regulator (not shown) to cause the voltage regulator to generate the appropriate regulated voltage. PCU 317 also provides control information to control the operating voltage generated. In various examples, PCU 317 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 317 is illustrated as being present as logic separate from the processor 370 and/or processor 380. In other cases, PCU 317 may execute on a given one or more of cores (not shown) of processor 370 or 380. In some cases, PCU 317 may be implemented as a microcontroller (dedicated or general-purpose) or other control logic configured to execute its own dedicated power management code, sometimes referred to as P-code. In yet other examples, power management operations to be performed by PCU 317 may be implemented externally to a processor, such as by way of a separate power management integrated circuit (PMIC) or another component external to the processor. In yet other examples, power management operations to be performed by PCU 317 may be implemented within BIOS or other system software.

Various I/O devices 314 may be coupled to first interface 316, along with a bus bridge 318 which couples first interface 316 to a second interface 320. In some examples, one or more additional processor(s) 315, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 316. In some examples, second interface 320 may be a low pin count (LPC) interface. Various devices may be coupled to second interface 320 including, for example, a keyboard and/or mouse 322, communication devices 327 and storage circuitry 328. Storage circuitry 328 may be one or more non-transitory machine-readable storage media as described below, such as a disk drive or other mass storage device which may include instructions/code and data 330 and may implement the storage 'ISAB03 in some examples. Further, an audio I/O 324 may be coupled to second interface 320. Note that other architectures than the point-to-point architecture described above are possible. For example, instead of the point-to-point architecture, a system such as multiprocessor system 300 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

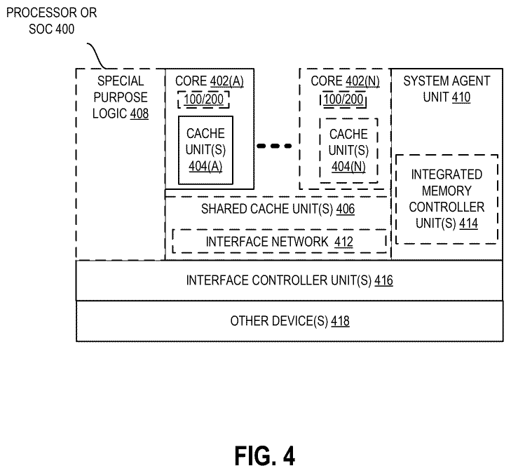

FIG. 4 illustrates a block diagram of an example processor and/or SoC 400 that may have one or more cores and an integrated memory controller. The solid lined boxes illustrate a processor 400 with a single core 402(A), system agent unit circuitry 410, and a set of one or more interface controller unit(s) circuitry 416, while the optional addition of the dashed lined boxes illustrates an alternative processor 400 with multiple cores 402(A)-(N), a set of one or more integrated memory controller unit(s) circuitry 414 in the system agent unit circuitry 410, and special purpose logic 408, as well as a set of one or more interface controller units circuitry 416. Note that the processor 400 may be one of the processors 370 or 380, or co-processor 338 or 315 of FIG. 3.

Thus, different implementations of the processor 400 may include: 1) a CPU with the special purpose logic 408 being integrated graphics and/or scientific (throughput) logic (which may include one or more cores, not shown), and the cores 402(A)-(N) being one or more general purpose cores (e.g., general purpose in-order cores, general purpose out-of-order cores, or a combination of the two); 2) a coprocessor with the cores 402(A)-(N) being a large number of special purpose cores intended primarily for graphics and/or scientific (throughput); and 3) a coprocessor with the cores 402(A)-(N) being a large number of general purpose in-order cores. Thus, the processor 400 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 400 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 404(A)-(N) within the cores 402(A)-(N), a set of one or more shared cache unit(s) circuitry 406, and external memory (not shown) coupled to the set of integrated memory controller unit(s) circuitry 414. The set of one or more shared cache unit(s) circuitry 406 may include one or more mid-level caches, such as level 2(L 2 ), level 3(L 3 ), level 4(L 4 ), or other levels of cache, such as a last level cache (LLC), and/or combinations thereof. While in some examples interface network circuitry 412 (e.g., a ring interconnect) interfaces the special purpose logic 408 (e.g., integrated graphics logic), the set of shared cache unit(s) circuitry 406, and the system agent unit circuitry 410, alternative examples use any number of well-known techniques for interfacing such units. In some examples, coherency is maintained between one or more of the shared cache unit(s) circuitry 406 and cores 402(A)-(N). In some examples, interface controller units circuitry 416 couple the cores 402 to one or more other devices 418 such as one or more I/O devices, storage, one or more communication devices (e.g., wireless networking, wired networking, etc.), etc.

In some examples, one or more of the cores 402(A)-(N) are capable of multi-threading. The system agent unit circuitry 410 includes those components coordinating and operating cores 402(A)-(N). The system agent unit circuitry 410 may include, for example, power control unit (PCU) circuitry and/or display unit circuitry (not shown). The PCU may be or may include logic and components needed for regulating the power state of the cores 402(A)-(N) and/or the special purpose logic 408 (e.g., integrated graphics logic). The display unit circuitry is for driving one or more externally connected displays.

The cores 402(A)-(N) may be homogenous in terms of instruction set architecture (ISA). Alternatively, the cores 402(A)-(N) may be heterogeneous in terms of ISA; that is, a subset of the cores 402(A)-(N) may be capable of executing an ISA, while other cores may be capable of executing only a subset of that ISA or another ISA.

### Example Core Architectures—in-Order and Out-of-Order Core Block Diagram

FIG. 5(A) is a block diagram illustrating both an example in-order pipeline and an example register renaming, out-of-order issue/execution pipeline according to examples. FIG. 5(B) is a block diagram illustrating both an example in-order architecture core and an example register renaming, out-of-order issue/execution architecture core to be included in a processor according to examples. The solid lined boxes in FIG. 5(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 5(A), a processor pipeline 500 includes a fetch stage 502, an optional length decoding stage 504, a decode stage 506, an optional allocation (Alloc) stage 508, an optional renaming stage 510, a schedule (also known as a dispatch or issue) stage 512, an optional register read/memory read stage 514, an execute stage 516, a write back/memory write stage 518, an optional exception handling stage 522, and an optional commit stage 524. One or more operations can be performed in each of these processor pipeline stages. For example, during the fetch stage 502, one or more instructions are fetched from instruction memory, and during the decode stage 506, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 506 and the register read/memory read stage 514 may be combined into one pipeline stage. In one example, during the execute stage 516, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 5(B) may implement the pipeline 500 as follows: 1) the instruction fetch circuitry 538 performs the fetch and length decoding stages 502 and 504; 2) the decode circuitry 540 performs the decode stage 506; 3) the rename/allocator unit circuitry 552 performs the allocation stage 508 and renaming stage 510; 4) the scheduler(s) circuitry 556 performs the schedule stage 512; 5) the physical register file(s) circuitry 558 and the memory unit circuitry 570 perform the register read/memory read stage 514; the execution cluster(s) 560 perform the execute stage 516; 6) the memory unit circuitry 570 and the physical register file(s) circuitry 558 perform the write back/memory write stage 518; 7) various circuitry may be involved in the exception handling stage 522; and 8) the retirement unit circuitry 554 and the physical register file(s) circuitry 558 perform the commit stage 524.

FIG. 5(B) shows a processor core 590 including front-end unit circuitry 530 coupled to execution engine unit circuitry 550, and both are coupled to memory unit circuitry 570. The core 590 may be a reduced instruction set architecture computing (RISC) core, a complex instruction set architecture computing (CISC) core, a very long instruction word (VLIW) core, or a hybrid or alternative core type. As yet another option, the core 590 may be a special-purpose core, such as, for example, a network or communication core, compression engine, coprocessor core, general purpose computing graphics processing unit (GPGPU) core, graphics core, or the like.

The front-end unit circuitry 530 may include branch prediction circuitry 532 coupled to instruction cache circuitry 534, which is coupled to an instruction translation lookaside buffer (TLB) 536, which is coupled to instruction fetch circuitry 538, which is coupled to decode circuitry 540. In one example, the instruction cache circuitry 534 is included in the memory unit circuitry 570 rather than the front-end circuitry 530. The decode circuitry 540 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 540 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 540 may be implemented using various different mechanisms. Examples of suitable mechanisms include, but are not limited to, look-up tables, hardware implementations, programmable logic arrays (PLAs), microcode read only memories (ROMs), etc. In one example, the core 590 includes a microcode ROM (not shown) or other medium that stores microcode for certain macroinstructions (e.g., in decode circuitry 540 or otherwise within the front-end circuitry 530). In one example, the decode circuitry 540 includes a micro-operation (micro-op) or operation cache (not shown) to hold/cache decoded operations, micro-tags, or micro-operations generated during the decode or other stages of the processor pipeline 500. The decode circuitry 540 may be coupled to rename/allocator unit circuitry 552 in the execution engine circuitry 550.

The execution engine circuitry 550 includes the rename/allocator unit circuitry 552 coupled to retirement unit circuitry 554 and a set of one or more scheduler(s) circuitry 556. The scheduler(s) circuitry 556 represents any number of different schedulers, including reservations stations, central instruction window, etc. In some examples, the scheduler(s) circuitry 556 can include arithmetic logic unit (ALU) scheduler/scheduling circuitry, ALU queues, address generation unit (AGU) scheduler/scheduling circuitry, AGU queues, etc. The scheduler(s) circuitry 556 is coupled to the physical register file(s) circuitry 558. Each of the physical register file(s) circuitry 558 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 558 includes vector registers unit circuitry, writemask registers unit circuitry, and scalar register unit circuitry. These register units may provide architectural vector registers, vector mask registers, general-purpose registers, etc. The physical register file(s) circuitry 558 is coupled to the retirement unit circuitry 554 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 554 and the physical register file(s) circuitry 558 are coupled to the execution cluster(s) 560. The execution cluster(s) 560 includes a set of one or more execution unit(s) circuitry 562 and a set of one or more memory access circuitry 564. The execution unit(s) circuitry 562 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 556, physical register file(s) circuitry 558, and execution cluster(s) 560 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 564). It should also be understood that where separate pipelines are used, one or more of these pipelines may be out-of-order issue/execution and the rest in-order.

In some examples, the execution engine unit circuitry 550 may perform load store unit (LSU) address/data pipelining to an Advanced Microcontroller Bus (AMB) interface (not shown), and address phase and writeback, data phase load, store, and branches.

The set of memory access circuitry 564 is coupled to the memory unit circuitry 570, which includes data TLB circuitry 572 coupled to data cache circuitry 574 coupled to level 2(L 2 ) cache circuitry 576. In one example, the memory access circuitry 564 may include load unit circuitry, store address unit circuitry, and store data unit circuitry, each of which is coupled to the data TLB circuitry 572 in the memory unit circuitry 570. The instruction cache circuitry 534 is further coupled to the level 2 (L2) cache circuitry 576 in the memory unit circuitry 570. In one example, the instruction cache 534 and the data cache 574 are combined into a single instruction and data cache (not shown) in L2 cache circuitry 576, level 3 (L3) cache circuitry (not shown), and/or main memory. The L2 cache circuitry 576 is coupled to one or more other levels of cache and eventually to a main memory.

The core 590 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 590 includes logic to support a packed data instruction set architecture extension (e.g., AVX1, AVX2), thereby allowing the operations used by many multimedia applications to be performed using packed data.

Example Execution Unit(s) Circuitry

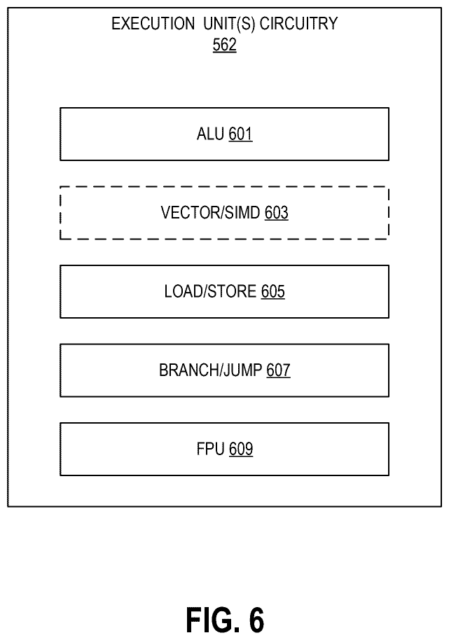

FIG. 6 illustrates examples of execution unit(s) circuitry, such as execution unit(s) circuitry 562 of FIG. 5(B). As illustrated, execution unit(s) circuity 562 may include one or more ALU circuits 601, optional vector/single instruction multiple data (SIMD) circuits 603, load/store circuits 605, branch/jump circuits 607, and/or Floating-point unit (FPU) circuits 609. ALU circuits 601 perform integer arithmetic and/or Boolean operations. Vector/SIMD circuits 603 perform vector/SIMD operations on packed data (such as SIMD/vector registers). Load/store circuits 605 execute load and store instructions to load data from memory into registers or store from registers to memory. Load/store circuits 605 may also generate addresses. Branch/jump circuits 607 cause a branch or jump to a memory address depending on the instruction. FPU circuits 609 perform floating-point arithmetic. The width of the execution unit(s) circuitry 562 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes a processor comprising: a decoder to receive an instruction; and a Micro Sequencer Unit (MSU) to receive a decode request for the instruction from the decoder in response to a determination by the decoder that the instruction is complex, wherein the decode request is to include additional information to allow the MSU to decode the instruction without further communication with the decoder. Example 2 includes the processor of example 1, wherein the MSU comprises one or more Micro Sequencer Decoded Uop Queues (MSDUQs) to store a plurality of micro operations, wherein the plurality of micro operations are to be generated based on decoding of the instruction. Example 3 includes the processor of example 1, wherein the MSU comprises a Micro Sequencer Request Queue (MSRQ) to store the received decode request prior to decoding of the instruction by the MSU.

Example 4 includes the processor of example 3, wherein the decoder is to stall until after the decode request has been successfully written to the MSRQ. Example 5 includes the processor of example 1, wherein the complex instruction is to be decoded into more than four micro operations. Example 6 includes the processor of example 1, wherein the decoder proceeds to decoding of a subsequent instruction after the decode request is received by the MSU. Example 7 includes the processor of example 1, wherein the additional information comprises at least one of: a Micro Sequencer (MS) entry micro operation (uop) instruction pointer, an indicator corresponding to inserted flow, one or more fast branch bits, and a macro alias register.

Example 8 includes the processor of example 1, wherein the MSU comprises a micro operation aliasing logic. Example 9 includes the processor of example 1, further comprising a global ordering and merge multiplexer to order a plurality of micro operations, to be generated based on decoding of the instruction, by age. Example 10 includes the processor of example 1, further comprising a global ordering and merge multiplexer to store a plurality of micro operations, to be generated based on decoding of the instruction, in a unified decoded uop buffer. Example 11 includes the processor of example 1, further comprising a global ordering and merge multiplexer to order a plurality of micro operations, to be generated based on decoding of the instruction, by age and to store the ordered plurality of micro operations in a unified decoded uop buffer.

Example 12 includes the processor of example 1, wherein a System on Chip (SoC) comprises the MSU and the decoder. Example 13 includes the processor of example 1, wherein the processor comprises one or more processor cores, wherein each of the one or more processor cores comprises the MSU and the decoder. Example 14 includes one or more non-transitory computer-readable media comprising one or more instructions that when executed on a processor configure the processor to perform one or more operations to cause: a decoder to receive an instruction; and a Micro Sequencer Unit (MSU) to receive a decode request for the instruction from the decoder in response to a determination that the instruction is complex, wherein the decode request is to include additional information to allow the MSU to decode the instruction without further communication with the decoder.

Example 15 includes the one or more non-transitory computer-readable media of example 14, further comprising one or more instructions that when executed on the processor configure the processor to perform one or more operations to cause one or more Micro Sequencer Decoded Uop Queues (MSDUQs) of the MSU to store a plurality of micro operations, wherein the plurality of micro operations are to be generated based on decoding of the instruction. Example 16 includes the one or more non-transitory computer-readable media of example 14, further comprising one or more instructions that when executed on the processor configure the processor to perform one or more operations to cause a Micro Sequencer Request Queue (MSRQ) of the MSU to store the received decode request prior to decoding of the instruction by the MSU.

Example 17 includes the one or more non-transitory computer-readable media of example 16, further comprising one or more instructions that when executed on the processor configure the processor to perform one or more operations to cause the decoder to stall until after the decode request has been successfully written to the MSRQ. Example 18 includes the one or more non-transitory computer-readable media of example 14, further comprising one or more instructions that when executed on the processor configure the processor to perform one or more operations to cause decoding of the complex instruction into more than four micro operations.

Example 19 includes the one or more non-transitory computer-readable media of example 14, further comprising one or more instructions that when executed on the processor configure the processor to perform one or more operations to cause the decoder to proceed to decoding of a subsequent instruction after the decode request is received by the MSU. Example 20 includes the one or more non-transitory computer-readable media of example 14, wherein the additional information comprises at least one of: a Micro Sequencer (MS) entry micro operation (uop) instruction pointer, and an indicator corresponding to inserted flow, one or more fast branch bits, and a macro alias register.

Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A processor comprising:
a decoder to receive an instruction; and
a Micro Sequencer Unit (MSU) to receive a decode request for the instruction from the decoder in response to a determination by the decoder that the instruction is complex,
wherein the decode request is to include additional information to allow the MSU to decode the instruction without further communication with the decoder.

2. The processor of claim 1, wherein the MSU comprises one or more Micro Sequencer Decoded Uop Queues (MSDUQs) to store a plurality of micro operations, wherein the plurality of micro operations are to be generated based on decoding of the instruction.

3. The processor of claim 1, wherein the MSU comprises a Micro Sequencer Request Queue (MSRQ) to store the received decode request prior to decoding of the instruction by the MSU.

4. The processor of claim 3, wherein the decoder is to stall until after the decode request has been successfully written to the MSRQ.

5. The processor of claim 1, wherein the complex instruction is to be decoded into more than four micro operations.

6. The processor of claim 1, wherein the decoder proceeds to decoding of a subsequent instruction after the decode request is received by the MSU.

7. The processor of claim 1, wherein the additional information comprises at least one of: a Micro Sequencer (MS) entry micro operation (uop) instruction pointer, an indicator corresponding to inserted flow, one or more fast branch bits, and a macro alias register.

8. The processor of claim 1, wherein the MSU comprises a micro operation aliasing logic.

9. The processor of claim 1, further comprising a global ordering and merge multiplexer to order a plurality of micro operations, to be generated based on decoding of the instruction, by age.

10. The processor of claim 1, further comprising a global ordering and merge multiplexer to store a plurality of micro operations, to be generated based on decoding of the instruction, in a unified decoded uop buffer.

11. The processor of claim 1, further comprising a global ordering and merge multiplexer to order a plurality of micro operations, to be generated based on decoding of the instruction, by age and to store the ordered plurality of micro operations in a unified decoded uop buffer.

12. The processor of claim 1, wherein a System on Chip (SoC) comprises the MSU and the decoder.

13. The processor of claim 1, wherein the processor comprises one or more processor cores, wherein each of the one or more processor cores comprises the MSU and the decoder.

14. One or more non-transitory computer-readable media comprising one or more instructions that when executed on a processor configure the processor to perform one or more operations to cause:
a decoder to receive an instruction; and
a Micro Sequencer Unit (MSU) to receive a decode request for the instruction from the decoder in response to a determination that the instruction is complex,
wherein the decode request is to include additional information to allow the MSU to decode the instruction without further communication with the decoder.

15. The one or more non-transitory computer-readable media of claim 14, further comprising one or more instructions that when executed on the processor configure the processor to perform one or more operations to cause one or more Micro Sequencer Decoded Uop Queues (MSDUQs) of the MSU to store a plurality of micro operations, wherein the plurality of micro operations are to be generated based on decoding of the instruction.

16. The one or more non-transitory computer-readable media of claim 14, further comprising one or more instructions that when executed on the processor configure the processor to perform one or more operations to cause a Micro Sequencer Request Queue (MSRQ) of the MSU to store the received decode request prior to decoding of the instruction by the MSU.

17. The one or more non-transitory computer-readable media of claim 16, further comprising one or more instructions that when executed on the processor configure the processor to perform one or more operations to cause the decoder to stall until after the decode request has been successfully written to the MSRQ.

18. The one or more non-transitory computer-readable media of claim 14, further comprising one or more instructions that when executed on the processor configure the processor to perform one or more operations to cause decoding of the complex instruction into more than four micro operations.

19. The one or more non-transitory computer-readable media of claim 14, further comprising one or more instructions that when executed on the processor configure the processor to perform one or more operations to cause the decoder to proceed to decoding of a subsequent instruction after the decode request is received by the MSU.

20. The one or more non-transitory computer-readable media of claim 14, wherein the additional information comprises at least one of: a Micro Sequencer (MS) entry micro operation (uop) instruction pointer, and an indicator corresponding to inserted flow, one or more fast branch bits, and a macro alias register.
